(19) United States
(12) Patent Application Publication
(10) Pub. No.: US 2005/0161486 A1
(43) Pub. Date: Jul. 28, 2005

(54) Apparatus and method for forming perforated band joist insulation

(76) Inventors: Michael J. Lembo, Souderton, PA (US); Murray S. Toas, Norristown, PA (US); Eric Brown, Collegeville, PA (US); Eric Nilsson, Exton, PA (US)

Correspondence Address: DUANE MORRIS, LLP;IP DEPARTMENT, ONE LIBERTY PLACE, PHILADELPHIA, PA, 19103-7396, US

(21) Appl. No.: 10/763,873

(22) Filed: Jan. 23, 2004

(51) Int. Cl. B26F 3/00

(52) U.S. Cl. 225/2; 225/4; 225/100; 83/346

(57) ABSTRACT

An insulation manufacturing apparatus includes a conveyor for conveying the insulation, a rotary die cutting cylinder having at least one slicing or perfing rule and at least one cutting rule, and an anvil cooperative with the rotary die cutting cylinder for partially slicing, perforating or severing the insulation. The rotary die cutting cylinder is located along a path of the conveyor.

### FIELD OF THE INVENTION

The present invention relates to building insulation, and more particularly to apparatuses and methods for manufacturing insulation batts for band joist spaces.

### BACKGROUND OF THE INVENTION

Insulation blankets formed from mineral fibers, very often fiberglass, are well known and have long been used for building insulation. Generally, the insulation blankets are packaged in sizes conforming to standard sizes of structural framework building cavities formed by wall studs, roof rafters, and the like. For example, the typical spacing between many framing members used in residential houses is approximately 14½ inches or 22½ inches. Therefore, insulation blankets are normally manufactured to be about 15 inches or 23 inches in width so that they can be slightly compressed to fit snugly into the 14½ inch or 22½ inch spacing.

Referring to FIG. 1, in housing construction, there are usually multiple band joist spaces which require insulation. As shown in the partial flooring structure of FIG. 1, residential housing usually is constructed having a foundation wall 200, a sill plate 202, floor joists 204, band joists 206 and insulation 208. The space above the sill plate 202, against the band joist 206 and between the floor joists 204 and the floor—not shown, for clarity—above the sill plate and joists is a band joist space. These band joist spaces are typically about 16 inches on center and between 8 and 12 inches high, for example, 10 inches in height. To insulate these band joist spaces, an installer will usually cut a standard-sized insulation batt at the job site with a knife to fit the band joist space. This process can be time consuming, creates scraps, and raises safety concerns. Further, the effectiveness of the insulation is dependent upon the skill level of the installer in correctly cutting the batt to fit the band joist space.

### SUMMARY OF THE INVENTION

One aspect of the present invention is an apparatus for manufacturing insulation including a conveying means for conveying the insulation, a rotary die cutting cylinder having at least one slicing or perfing rule and at least one cutting rule, and an anvil cooperative with the rotary die cutting cylinder for partially slicing, perforating or severing the insulation. The rotary die cutting cylinder is located along a path of the conveying means.

Another aspect of the present invention is a method of manufacturing batts for insulating band joist spaces including providing a rotary die cutting cylinder having at least one slicing or perfing rule and at least one cutting rule, conveying an insulation batt to the rotary die cutting cylinder; and partially cutting the batt transversely with the rotary die cutting cylinder to form a plurality of separable segments sized for insulating band joist spaces.

### BRIEF DESCRIPTION OF THE DRAWINGS

FIG. 1 is a perspective view of a partial flooring structure;

FIG. 2 is a side view of an exemplary insulation manufacturing apparatus;

FIG. 3A is a cross sectional view of an exemplary rotary die cutting cylinder;

FIG. 3B is an isometric view of the die cutting cylinder of FIG. 3A.

FIG. 4 is a cross sectional view of another exemplary rotary die cutting cylinder;

FIG. 5 is a cross sectional view of a third exemplary rotary die cutting cylinder;

FIG. 6 is a front view of an exemplary slicing rule;

FIG. 7 is a front view of an exemplary perfing rule; and

FIG. 8 is a front view of an exemplary cutting rule.

FIG. 9A is a plan view of a section or lane of insulation that has been processed into three batts, each batt having perforations to form four separable segments.

FIG. 9B is a side elevation view of a section or lane of insulation that has been processed into three batts, each batt partially cut through its thickness by a slicing rule to form four separable segments.

FIG. 10 is a plan view of a batt having two continuous lanes, each lane being cut into three portions, each portion having four separable segments.

FIG. 11 is a side elevation view of a process and for automatically separating product produced by a die cutting cylinder having only perfing blades.

FIG. 12 is a side elevation view of an alternative apparatus for automatically separating product.

FIG. 13 is a side elevation view of another alternative apparatus for automatically separating product.

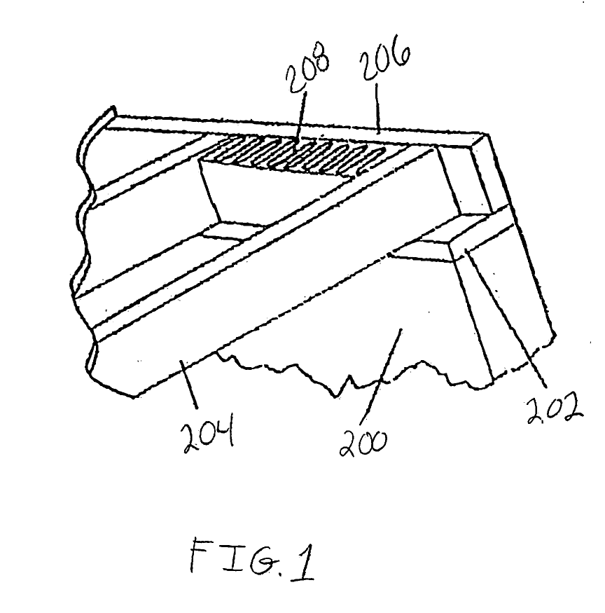

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

FIG. 2 shows an insulation manufacturing apparatus 100. The apparatus is suitable for use in the fabrication of thermal and acoustical insulation products comprising, for example, mineral fibers, polymer fibers, compressible foam, and the like. The apparatus comprises two conveyor belts 10, 12, a rotary die cutting cylinder 20, and an anvil 40. The die cutting cylinder 20 and anvil 40 may be part of a die cutting system, such as a soft anvil web-fed rotary die cutter. The insulation manufacturing apparatus 100 may be a stand alone apparatus capable of processing standard insulation batts 50 into batts more readily usable for band joist spaces, but preferably the insulation manufacturing apparatus 100 is part of an in-line insulation manufacturing process, and is employed in the process after formation of the fibrous batt 50 and prior to the packaging process. Alternatively, the apparatus may process rolls of insulation, or continuous lanes of insulation.

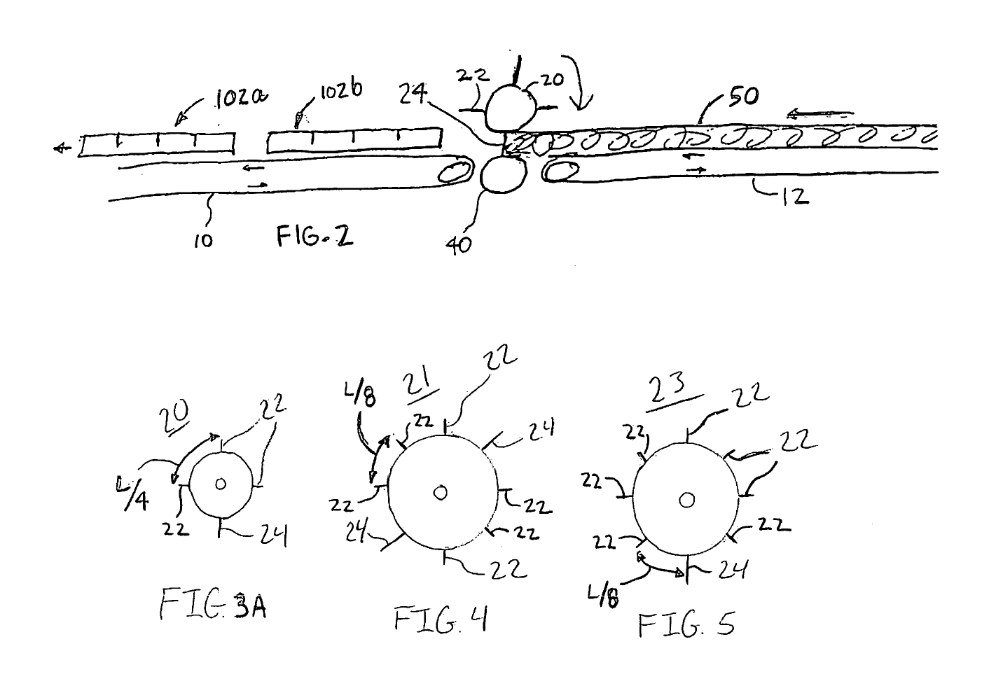

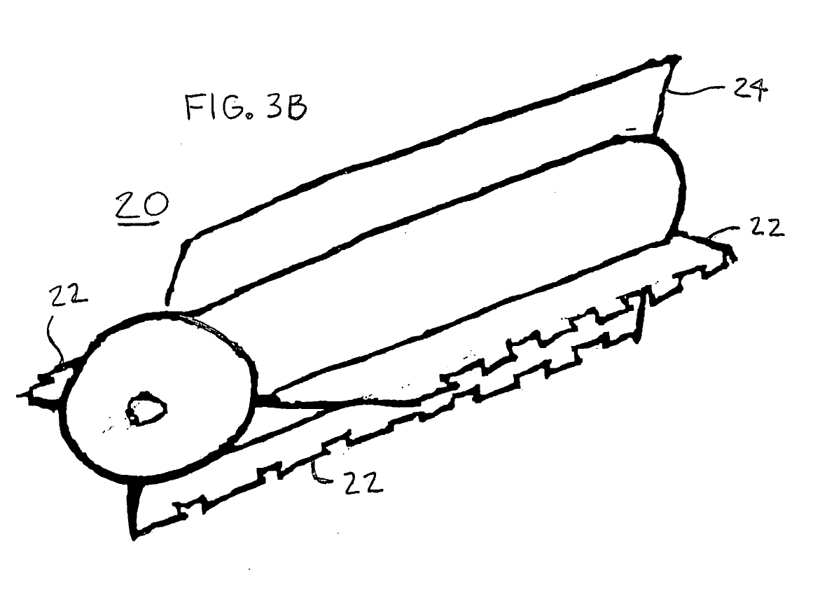

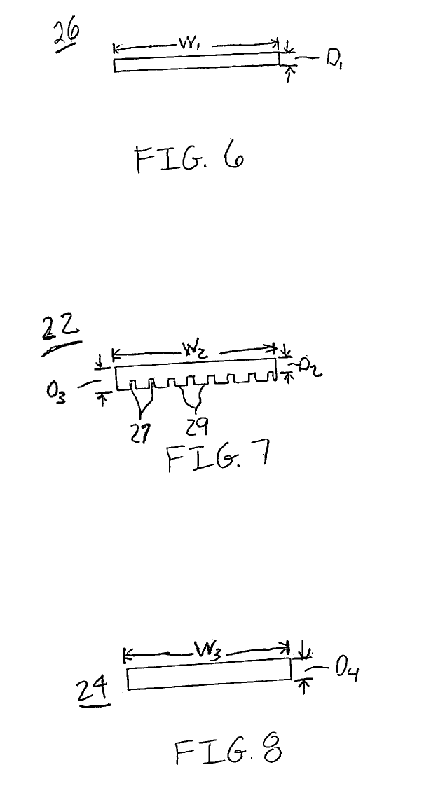

Referring to FIGS. 3A-5, the rotary die cutting cylinder 20, 21, 23 preferably includes one or more (preferably two or more) slicing rules 26 or perfing rules 22, and at least one cutting rule 24. The rotary die cutting system may be of the type manufactured by CORfine of Dayton, Ohio, for example. The slicing or perfing rules 26 or 28 are used to partially slice or to perforate the batt 50 (or roll or continuous lane) at desired distances so that the batt (or roll or continuous lane) can be easily separated at the areas of the slices or perforations to readily fit into band joist spaces. Herein, the term “slice” is used to indicate partially cutting through the insulation, cutting less than the complete depth of the batt, leaving some portion of the mat undisturbed across the total width of the mat. In contrast, the term “perf” is used herein to denote cutting all the way through the entire depth of the insulation, except in stepped areas, which are partially cut or not cut at all.

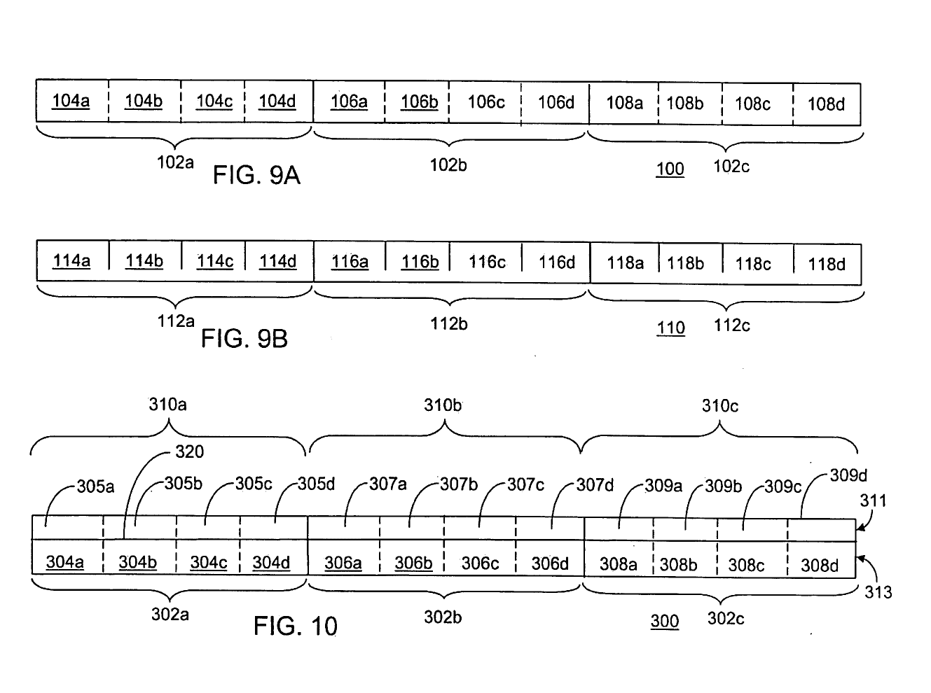

The cutting rule is used to completely sever the batt 50, roll or lane to allow for packaging. In one preferred embodiment, as shown in FIGS. 2, 3A and 3B, the rotary die cutting cylinder 20 includes 3 perfing rules 22 and one cutting rule 24 for forming a batt, roll or lane having four separable segments. FIG. 9A shows a section or lane of insulation 100 that is processed by the die cutting cylinder 20 of FIGS. 2, 3A and 3B. FIG. 9A is a plan view, showing the perforations and cuts across the width of the insulation. The section or lane of insulation 100 is divided into three batts 102a-102c. Each batt 102a-102c is in turn divided into four separable segments: batt 102a is divided into segments 104a-104d; batt 102b is divided into segments 106a-106d, and batt 102c is divided into segments 108a-108d. FIG. 9B is a side elevation view, showing slices (instead of perforations) made to form the separable segments.

In the example, for evenly sized separable segments, the die cutting cylinder 20 circumference L is sized as an integer multiple (1 or larger) of the length of the segmented batt to be cut. With four separable segments, the three rules 22 and 24 are evenly spaced at distances L/4 along the circumference of the die cutting cylinder. In alternative embodiments, if differently sized segments are desired, the rules may be separated by respectively different distances along the circumference.

FIG. 9B is a side elevation view of a section or lane of insulation 110 that is processed by a die cutting cylinder similar to cylinder 20, but having slicing rules 26 instead of perfing rules 22. FIG. 9B shows the partial cuts which may extend nearly all the way through the insulation. The section or lane of insulation 110 is divided into three batts 112a-112c. Each batt 112a-112c is in turn divided into four separable segments: batt 112a is divided into segments 114a-114d; batt 112b is divided into segments 116a-116d, and batt 112c is divided into segments 118a-118d.

FIG. 10 shows an example of insulation provided in the form of continuous lanes 311 and 313. Continuous lanes 311, 313 may be formed in a fibrous layer of insulation 300 including a first (or top) major surface and a second (or bottom) major surface, by making at least one longitudinal cut 320. In forming the continuous lanes, the fibrous layer 300 is fed through a cutting station (not shown) where rotary saws or other cutting means separates the fibrous layer into individual lanes 311, 313. The at least one longitudinal cut 320 extends from the first surface to the second surface and for the length of the insulation blanket 300, separating the fibrous layer into two or more continuous lanes 311, 313. At one or more locations along the longitudinal cut(s) 320, on one or both of the inner sidewalls of adjacent continuous lanes 311, 313, an adhesive may optionally be applied to bond the adjacent lanes 311, 313 together. If used, the adhesive is preferably a hot melt glue, such as sold by Henkel America as Product No. 80-8273. The adhesive is preferably applied at approximately a midpoint between the top and bottom major surfaces.

The cut(s) 320 can optionally be perforated cuts, such as those produced by a perforated cutting wheel. Any desired number N−1 of cuts may be made, to form N continuous lanes. The cuts 320 divide each separable lane, so that lengths of insulation 302a, 302b, and 302c in the lane 313 are divided into separable segments 304a-304d, 306a-306d, and 308a-308d, and lengths of insulation 310a-310d in the lane 311 are divided into separable segments 305a-305d, 307a-307d, and 309a-309d.

Additional details of preferred methods for making insulation products having a plurality of continuous lanes are described in U.S. patent application Ser. No. 10/690,295, filed Oct. 21, 2003, which is incorporated by reference herein in its entirety.

In another preferred embodiment, as shown in FIG. 4, the rotary die cutting cylinder 21 includes six perfing rules 22 and two cutting rules 24 for forming two batts in a single rotation of the cylinder 21, each batt having four separable segments. The rules 22 and 24 are spaced at a distance L/8 apart around the circumference L. The cutting rules are 180 degrees apart around the circumference, to make evenly sized batts. In a variation of the cylinder 21, the perfing rules 22 may be replaced by slicing rules 26. In a third preferred embodiment, as shown in FIG. 5, the rotary die cutting cylinder 23 includes seven perfing rules 22 and one cutting rule 24 for forming a batt having eight separable segments spaced L/8 apart. Again, in a variation of the cylinder 23, the perfing rules 22 may be replaced by slicing rules 26. Any desired number of slicing or perfing rules, and cutting rules may be used in any desired sequence on the die cutting cylinder.

The circumference of the rotary die cutting cylinder 20 may vary depending on the desired length of the final processed batt. Preferably, the circumference ranges from about 24 inches to about 120 inches. More preferably, the circumference is 50 inches (using three perfing or slicing rules and one cutting rule to form a 50 inch batt with four perforated or sliced (partially cut) regions 12.5 inches apart (see FIG. 3)) or 100 inches (using seven perfing or slicing rules and one cutting rule to form a 100 inch batt with eight perforated or sliced (partially cut) regions 12.5 inches apart (see FIG. 5), or using six perfing or slicing rules and two cutting rules to form two 50 inch batts, each having four perforated or sliced (partially cut) regions 12.5 inches apart (see FIG. 4)).

FIGS. 6-8 show examples of a slicing rule 26, a perfing rule 22 and a cutting rule 24, respectively. An example of a rule may be a steel ruled die having a sharpened or serrated edge.

Referring to FIG. 6, in some embodiments, a slicing rule 26 may be used instead of the perfing rule 22. The depth D₁ of the slicing rule preferably ranges from a depth of about 1 inch to about 6 inches (for an R19 batt of 6 to 7 inches thickness), which is sufficient to leave from about one eighth inch to one half of the batt (approximately three inches in the case of glass fiber insulation having a thickness of 6 inches (R-19)) uncut. More preferably, the depth of the slicing rule is set to leave one-quarter inch to one inch of the batt uncut. Fiber glass and mineral fiber insulation are compressible products. Therefore a wide range of depth of cut can be achieved through the use of a single depth rule mounted to a rotary die cutting cylinder where the cylinder height above the insulation is adjustable. The depth of the cut may be adjusted by the height of the cutting roll above the anvil. The width W1 of the slicing rule 26 is a minimum of 15 inches (preferably about 17 inches) for 15 inch wide insulation or a minimum of 23 inches (preferably about 25 inches) for 23 inch wide batts, to correspond to the typical widths of glass fiber insulation (The 17 and 25 inch widths are sufficient to cover width and position tolerances on the 15 inch wide and 23 inch wide batts, respectively). It may be desirable to have die widths up to and including 120 inch in width in order to perform such actions on all lanes of products created (full width of up to a 10 foot wide line). In a preferred embodiment, the dies are approximately 48 inches wide, to accommodate 1, 2 or 3 lanes of 16 inch wide product and 1 or 2 lanes of 23 inch or 24 inch wide product.

Referring to FIG. 7, the depth D₂ of the perfing rule 22 at the stepped tooth region 27 also preferably ranges from a depth sufficient to leave about zero to one half of the batt uncut. Typically the stepped area would not be a sharpened or serrated portion of the blade, so that the depth of the cut goes from zero to one half of the batt depth. More preferably, the depth D₂ of the perfing rule 22 at the stepped tooth region 27 is set to leave most or all of the batt uncut. Preferably the height (D₃−D₂) of the steps in the perfing rule 22 are between approximately ⅛ to 1 inch. Preferably the depth D₃ of the perfing rule 22 at the unstepped regions 29 is sufficient to completely cut through the faced or unfaced batt. This depth D3 preferably ranges from approximately 1 inch to about 7 inches. Preferably, the perfing rule 22 is formed such that there is a 2 to 1 ratio of unstepped regions 29 to stepped regions 27. However, the ratio of stepped to unstepped width may be from 1:1 to 12:1. For example, the unstepped regions 29 may be two inches wide, followed by stepped regions 27 having a one half inch width (a 4:1 ratio). Other ratios may also be employed, including, for example, a 3:1 ratio of unstepped to stepped regions. The width W₂ of the perking rule 22 is a minimum of 15 or 23 inches, and preferably about 17 inches or about 25 inches to correspond to the typical widths of glass fiber insulation. Other preferred perfing rule widths of 48 or 120 inches may also be used.

Referring to FIG. 8, the cutting rule 24 preferably has a depth D₄ sufficient to completely sever the insulation. This depth may vary depending on the thickness of the insulation and also whether the insulation is faced or unfaced. For example, a seven inch depth could be used for R19 insulation. Alternatively, a single blade of a given depth can be used for a range of thicknesses. For example, a 1½ inch blade can be used for an R13 (4 inch) product and R19 product (6 to 7 inches) due to the ability of the rotary die cutting cylinder to compress the insulation products. As with the perfing rule 22 and slicing rule 26, the cutting rule is at least 15 or 23 inches wide, and preferably has a width W₃ of about 17 inches or about 25 inches. Other preferred widths of 48 or 120 (or any range from 15 inches to 120 inches) inches may also be used.

The perfing rules 22, slicing rules 26 and cutting rules 24 may be permanently attached to the rotary die cutting cylinder 20, 21, 23 or may be removable. Removable rules allows for the interchange of different types of rules on the same rotary die cutting cylinder.

Referring again to FIG. 2, the anvil 40 is located beneath the rotary die cutting cylinder 20 to facilitate the partial slicing, perforating or complete severing of the insulation. The anvil may be of any type known to one of ordinary skill in the art, including those manufactured by CORfine. The anvil may be a cylindrical roller of hard material (such as steel), for example. Alternatively, softer materials, such as rubber or rubber covered steel may be used. Alternatively, the anvil may have a flat cutting surface (not shown).

The conveying means may include conveyor belts 10, 12 located adjacent one another, but separated by a space sufficient to allow for a partial or complete cutting of the batt by the rotary die cutting cylinder 20. The conveyor belts 10, 12 may be of the type generally used in insulation batt manufacturing or any other type of conveyor belt known to one of skill in the art. Further, other types of conveying means may be employed, such as rollers, for example. In an alternative embodiment, the insulation manufacturing apparatus may include a single conveying means, such as a single conveyor belt, wherein the conveyor belt drops underneath the anvil while facilitating the movement of the insulation between the rotary die cutting cylinder and the anvil. (That is, rather than two discrete belts, a single belt can be one belt routed around pulleys to descend downward underneath the anvil and return to the input height after passing the anvil. In this configuration the insulation does not follow the conveyor path under the die cutter, but instead passes through the die cutter).

The speed of the rotary die cutting cylinder 20, 21, 23 is preferably synchronized with the speed of the conveyor belts 10, 12 (or other conveying means). Preferably these speeds range from about 50 feet per minute (linear speed of insulation movement) to about 300 feet per minute. More preferably, these speeds range from about 80 feet per minute to about 200 feet per minute. In examples where a separate conveyor belt is used to remove the product from the rotary die cutter, that conveyor may operate at an increased speed from the input conveyor and Rotary Die Cutter, in order to create gaps between finished batts of product (as shown in FIG. 2) for ease of packaging and other manufacturing processes.

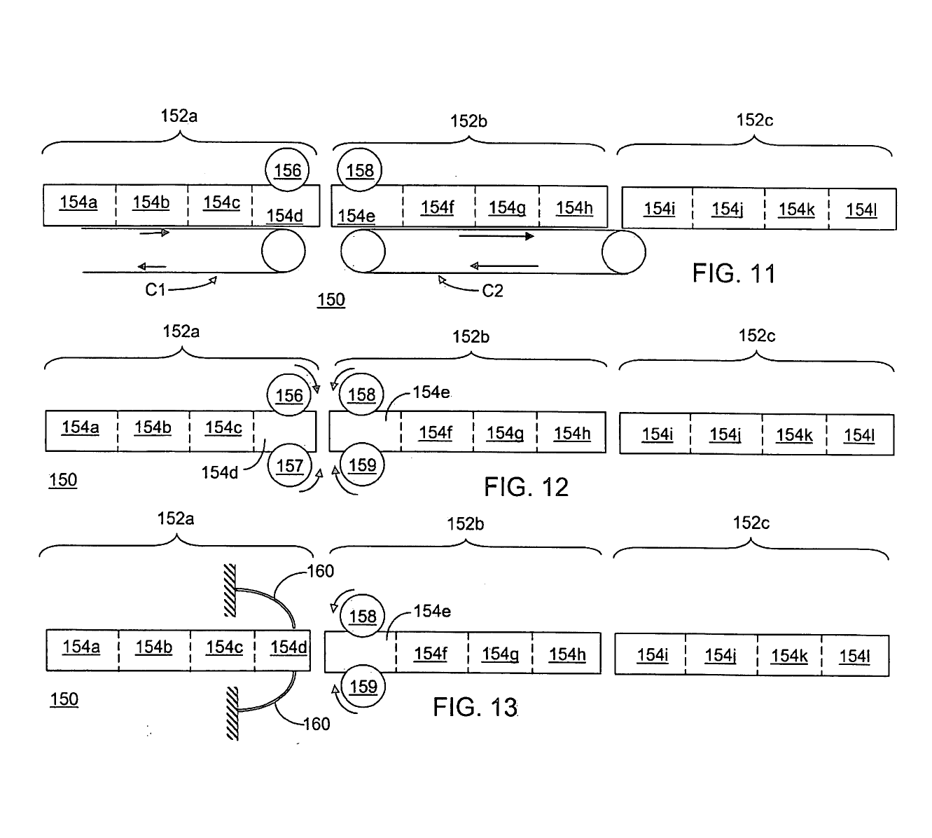

In an alternative embodiment, the rotary die cutting cylinder may include only perfing rules and no cutting rule. The result is a continuous roll or lane of insulation 150 with separable segments 154a-154l, as shown in FIG. 11. This embodiment may be preferred, for example, where the insulation will be packaged in the form of rolls as opposed to individual batts. In this embodiment, the insulation can be separated manually wherever desired, or may be passed through a separating chopping process to completely sever the insulation.

The roll or continuous lane passed through a die cutting cylinder with only perfing or slicing (partial cutting) rules can alternatively be converted into batts automatically. The separable segments of insulation are broken apart at the perforations or slices. An automatic device could be a conveyor and pinching roll system where the length of the insulation is measured/sensed automatically; when the defined or desired length is obtained, one roll on top of the insulation and a conveyor on the bottom can hold back the trailing edge and the second roll and conveyor underneath can push forward the leading edge.

FIGS. 11-13 shows three different tearing means for separating the segments of insulation. The insulation is carried to and from the separation section or tearing means by a conveyor or series of rollers (not shown). The tearing means of FIG. 11 includes means for conveying a first and a second adjacent separable segments at different speeds to tear the first and second separable segments apart from each other. Insulation 150 is input for separating along the perforations to form individual batts 152a-152c, having respective segments 154a-154d, 154e-154h, and 154i-154l. Roll 156 stops the leading edge of a segment (e.g., 154d), and roll 158 turns and pushes the trailing edge of a sliced/perfed batt (e.g., 152b) forward; this causes a tear at the desired sliced/perfed location, and separates the continuous lane or roll 150 into a series of batts 152a-152c. The location of the Roll 156 is over a first conveyor C1, and the roll 158 is over a second conveyor C2. The discharge conveyor (e.g., C2) can operate at a faster speed than the input conveyor (e.g., C1). This way the batt 150 can be accelerated by the discharge conveyor system C2 to break the batt between segments 154d and 154e.

Alternatively, using the same conveyors C1 and C2 in a batch mode, the conveyors can be started and stopped to feed a desired length of insulation 150 to the discharge conveyor C2; the direction of input conveyor C1 can then reverse, so that rollers pull the insulation in opposite directions to separate the two segments. The direction of input conveyor C1 is again changed to feed another length of insulation towards the discharge conveyor C2.

The tearing means of FIG. 12 includes means for pinching and holding or pulling back a first separable segment in a first direction and pinching and pulling forward a second separable segment adjacent the first separable segment in a second direction opposite the first direction. In the tearing means of FIG. 12 the insulation is separated using two pairs of pinch rollers: an input pair 156, 157 and a discharge pair 158, 159. The rollers can be operated in opposite directions as shown, to pull apart segments 154d and 154e.

The tearing means of FIG. 13 includes means for restraining a first separable segment and pulling an adjacent second separable segment away from the first separable segment In the tearing means of FIG. 13 a single set of rollers 158, 159 pulls the insulation forward towards a discharge end of the system. A pair of pincers 160 are provided in place of a second set of rolls or conveyor. The pincers serve to hold this continuous section 152a of insulation containing segments 154a-154d while the Rolls 158, 159 accelerate the sized batt 152b (containing segments 154e-154h) away from the continuous section 152a.

In other alternative embodiments (in which the rotary die cutting cylinder has only perfing blades), instead of including a tearing means, a separate chopping process may be provided with a chopper downstream of the rotary cutter for this purpose. The chopper may be, for example, of a type described in U.S. Pat. No. 5,765,318, which is incorporated by reference herein as though fully set forth in its entirety.

In another alternative embodiment for sizing, the Batt/Roll lengths are formed (chopped) prior to the perfing rotary cutter, and batts are accelerated to enter the rotary cutter one at a time. The timing on entering the rotary cutter is controlled by a signal device, such as a photo sensor or limit switch to ensure that the product enters at the start of a cutting cycle. Such a system may be more advantageous in a relatively slower process (or an off line process).

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

1. An apparatus for manufacturing insulation, comprising:
a conveying means for conveying said insulation;
a rotary die cutting cylinder located along a path of the conveying means and having at least one perfing or slicing rule and at least one cutting rule; and
an anvil cooperative with said rotary die cutting cylinder for partially slicing, perforating or severing said insulation.

2. The apparatus of claim 1, wherein said conveying means comprises two adjacent conveyor belts.

3. The apparatus of claim 2, wherein the rotary die cutting cylinder and anvil are located intermediate the two conveyor belts.

4. The apparatus of claim 1, wherein the rotary die cutting cylinder includes three perfing or slicing rules and one cutting rule.

5. The apparatus of claim 1, wherein the rotary die cutting cylinder includes six perfing or slicing rules and two cutting rules.

6. The apparatus of claim 1, wherein the rotary die cutting cylinder includes seven perfing or slicing rules and one cutting rule.

7. The apparatus of claim 1, wherein each perfing or slicing rule and cutting rule is approximately 17 or 25 inches in width.

8. The apparatus of claim 1, wherein the perfing or slicing rules and at least one cutting rule are removable.

9. The apparatus of claim 1, wherein the rotary die cutting cylinder has a circumference of approximately fifty inches.

10. The apparatus of claim 9, wherein the rotary die cutting cylinder includes three perfing or slicing rules and one cutting rule, and wherein the rules are 12.5 inches apart along the circumference of the rotary die cutting cylinder.

11. The apparatus of claim 1, wherein the rotary die cutting cylinder has a circumference of approximately one hundred inches.

12. The apparatus of claim 11, wherein the rotary die cutting cylinder includes seven perfing or slicing rules and one cutting rule, and wherein the rules are 12.5 inches apart along the circumference of the rotary die cutting cylinder.

13. The apparatus of claim 11, wherein the rotary die cutting cylinder includes six perfing or slicing rules and two cutting rules, and wherein the rules are 12.5 inches apart along the circumference of the rotary die cutting cylinder, and wherein the rotary die cutting cylinder includes two sets of three consecutive perfing rules with cutting rules between the sets of perfing rules.

14. The apparatus of claim 1, further comprising means for automatically tearing the plurality of separable segments apart.

15. The apparatus of claim 14, wherein the tearing means includes means for conveying a first and a second adjacent separable segments at different speeds to tear the first and second separable segments apart from each other.

16. The apparatus of claim 14, wherein the tearing means includes means for pinching and holding a first separable segment in a first direction and pinching and pulling forward a second separable segment adjacent the first separable segment in a second direction opposite the first direction.

17. The apparatus of claim 14, wherein the tearing means includes means for restraining a first separable segment and pulling an adjacent second separable segment away from the first separable segment.

18. A method of manufacturing batts for insulating band joist spaces comprising:
providing a rotary die cutting cylinder having at least one perfing or slicing rule and at least one cutting rule;
conveying an insulation batt, roll or lane to the rotary die cutting cylinder; and
partially cutting the batt, roll or lane transversely with the rotary die cutting cylinder to form a plurality of separable segments sized for insulating band joist spaces.

19. The method of claim 18, further comprising completely severing the batt, roll or lane.

20. The method of claim 18, wherein the step of partially cutting comprises perforating the batt, roll or lane using a plurality of said perfing rules to form the plurality of separable segments.

21. The method of claim 18, wherein the step of partially cutting comprises transversely slicing the batt while leaving a horizontal connecting piece which connects the separable segments.

22. The method of claim 18, wherein the speed of rotation of the rotary die cutting cylinder is substantially synchronized with the speed of the insulation being conveyed to the rotary die cutting cylinder.

23. The method of claim 22, wherein the speed of the insulation being conveyed is between about 80 feet per minute to about 200 feet per minute.

24. The method of claim 18, further comprising automatically tearing the plurality of separable segments apart.

25. The method of claim 24, wherein step (b) includes pinching and holding a first separable segment in a first direction and pulling forward a second separable segment adjacent the first separable segment in a second direction opposite the first direction.

26. The method of claim 24, wherein step (b) includes conveying a first and a second adjacent separable segments at different speeds to tear the first and second separable segments apart from each other.

27. The method of claim 24, wherein step (b) includes restraining a first separable segment and pulling an adjacent second separable segment away from the first separable segment.

28. The apparatus of claim 1, wherein the rotary die cutting cylinder is oriented relative to the conveying means so that the insulation is partially sliced, perforated or severed transversely.
